(19) United States
(12) Patent Application Publication
(10) Pub. No.: US 2012/0225750 A1
(43) Pub. Date: Sep. 6, 2012

(54) TURBINE DRIVE-TRAIN APPARATUS

(75) Inventors: Justin Aaron Allen, Greenville, SC (US); Jason Dean Fuller, Simpsonville, SC (US); Karl Dean Minto, Ballston Lake, NY (US); Brian Allen Rittenhouse, Simpsonville, SC (US); Daniel Richard Waugh, Simpsonville, SC (US)

(73) Assignee: GENERAL ELECTRIC COMPANY, Schenectady, NY (US)

(21) Appl. No.: 13/038,495

(22) Filed: Mar. 2, 2011

(51) Int. Cl. F16H 61/48

(52) U.S. Cl. 477/3

(57) ABSTRACT

An apparatus configured to increase the operational range of a turbine is disclosed. In one embodiment, an apparatus includes: a turbine coupled to a driveshaft; a drive-train coupled to the driveshaft; a first torque convertor coupled to the drive-train, the first torque convertor being configured to deliver an operational torque to the drive-train; a second torque convertor coupled to the first torque convertor, the second torque convertor being configured to deliver a torque to the first torque convertor; a first motor coupled to the second torque convertor, the first motor being configured to deliver a power input to the second torque convertor; and a control system operably connected to at least one of the first torque convertor and the second torque convertor, the control system configured to monitor and adjust a speed of the drive-train by controlling at least one of the operational torque provided by the first torque converter and the torque provided by the second torque converter.

### BACKGROUND OF THE INVENTION

The subject matter disclosed herein relates to turbines and, more particularly, to an apparatus configured to enable steady low-speed turbine operation.

Some power plant systems, for example certain nuclear, simple-cycle and combined-cycle power plant systems, employ turbines in their design and operation. As each turbine does not become self-sustaining until it achieves a relatively high percentage of its designed full shaft speed, between about 90% and about 100% of design full shaft speed, each turbine is operably connected to a driveshaft whereby it may receive a power input assisting it in reaching a self-sustaining speed. One or more drive-trains may be coupled to the driveshaft, the drive-trains being used in part for transient operation, to manage and power the turbines and turbine rotors during mapping, start-up and cool-down periods. In operation, these drive-trains accelerate a turbine through low shaft speeds to a speed at which the turbine is self-sustaining.

In order to meet the high shaft power demands of the turbine, large torque converters and motors are designed into the drive-trains. However, these high power components may have mechanical limitations which result in a system which is unable to operate the turbine at a steady low-speed between about 2% and about 30% of full shaft design speed. The limited operational range which results from these mechanical limitations leads to increased compressor rubs, inefficient cranking and cool-down operations and gaps in aerodynamic mapping and testing plans which are used to create a profile of flow characteristics and element performance within the compressor and turbine. Therefore, it is desirable to increase the operational range of turbines, enabling operation across a range of design speeds, including steady operation at low design speeds between about 2% and about 30% of full shaft design speed. Some power plant systems use a sub-scale system to simulate and calculate mapping values for the turbine, creating a smaller version of the system which is then operable across a full range of speeds. These systems are expensive and take a long time to create and test. They provide mapping values which are converted estimates of values for steady low-speed operation on a full size turbine and they do not have an impact on the quality or duration of cool-down and start-up operations.

### BRIEF DESCRIPTION OF THE INVENTION

Systems for increasing the operational range of a turbine are disclosed. In one embodiment, an apparatus includes: a turbine coupled to a driveshaft; a drive-train coupled to the driveshaft; a first torque convertor coupled to the drive-train, the first torque convertor being configured to deliver an operational torque to the drive-train; a second torque convertor coupled to the first torque convertor, the second torque convertor being configured to deliver a torque to the first torque convertor; a first motor coupled to the second torque convertor, the first motor being configured to deliver a power input to the second torque convertor; and a control system operably connected to at least one of the first torque convertor and the second torque convertor, the control system configured to monitor and adjust a speed of the drive-train by controlling at least one of the operational torque provided by the first torque converter and the torque provided by the second torque converter.

A first aspect of the invention provides an apparatus including: a turbine coupled to a driveshaft; a drive-train coupled to the driveshaft; a first torque convertor coupled to the drive-train, the first torque convertor being configured to deliver an operational torque to the drive-train; a second torque convertor coupled to the first torque convertor, the second torque convertor being configured to deliver a torque to the first torque convertor; a first motor coupled to the second torque convertor, the first motor being configured to deliver a power input to the second torque convertor; and a control system operably connected to at least one of the first torque convertor and the second torque convertor, the control system configured to monitor and adjust a speed of the drive-train by controlling at least one of the operational torque provided by the first torque converter and the torque provided by the second torque converter.

A second aspect of the invention provides a system including: a dynamoelectric machine; a turbine operably connected to the dynamoelectric machine, the turbine including a driveshaft; and an apparatus operably connected to the turbine, the apparatus comprising: a drive-train coupled to the driveshaft of the turbine; a first torque convertor coupled to the drive-train, the first torque convertor being configured to deliver an operational torque to the drive-train; a second torque convertor coupled to the first torque convertor, the second torque convertor being configured to deliver a torque to the first torque convertor; a first motor coupled to the second torque convertor, the first motor being configured to deliver a power input to the second torque convertor; and a control system operably connected to at least one of the first torque convertor and the second torque convertor, the control system configured to monitor and adjust a speed of the drive-train by controlling at least one of the operational torque provided by the first torque converter and the torque provided by the second torque converter.

A third aspect of the invention provides an apparatus including: a drive-train; a first torque convertor coupled to the drive-train, the first torque convertor being configured to deliver an operational torque to the drive-train; a second torque convertor coupled to the first torque convertor, the second torque convertor being configured to deliver a torque to the first torque convertor; a first motor coupled to the second torque convertor, the first motor being configured to deliver a power input to the second torque convertor; and a control system operably connected to at least one of the first torque converter and the second torque converter, the control system adapted to control and adjust a speed of the drive-train by performing actions comprising: regulating an input of the first motor to the second torque convertor; monitoring a speed of the drive-train; and controlling an amount of torque conversion in at least one of the first torque convertor and the second torque convertor.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic top view of an embodiment of an apparatus in accordance with an aspect of the invention;

FIG. 2 shows a schematic top view of an embodiment of an apparatus in accordance with an aspect of the invention;

FIG. 3 shows a schematic top view of an embodiment of an apparatus in accordance with an aspect of the invention;

FIG. 4 shows a schematic side view of an embodiment of a drive-train apparatus in accordance with an aspect of the invention;

FIG. 5 shows a schematic view of portions of a multi-shaft combined cycle power plant in accordance with an aspect of the invention; and

FIG. 6 shows a schematic view of portions of a single-shaft combined cycle power plant in accordance with an aspect of the invention.

It is noted that the drawings of the disclosure may not be to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, aspects of the invention provide for systems configured to increase the operational range of a turbine, enabling the turbine to be operated at low-speeds for extended periods of time by employing a motor and torque converters connected in series to power and manage the turbine. The motor is operably connected to a first and a second torque converter which are operably connected to one another and communicatively connected to a control system. The first torque converter obtains a power input from the motor and, at the direction of the control system, the first and second torque converter convert the input into an operational torque which the second torque converter delivers to the turbine driveshaft via a drive-train. These systems may allow for maintaining and adjusting low-speed turbine operation, providing for more efficient start-up and cool-down operations and a more comprehensive mapping profile for the turbine and turbine elements.

In the art of power generation systems (including, e.g., nuclear reactors, steam turbines, gas turbines, etc.), turbines are often employed as part of the system and may include a drive-train for assisting the turbine in achieving a high shaft speed, e.g. where the turbine is self-sufficient. Typically, the drive-train may also assist the turbine with cool-down, cranking and mapping procedures. However, the torque, power, size and speed requirements which are designed into the drive-train to operate the turbine through transient states and at high-load applications may limit the operational versatility of the drive-train. The mechanical limitations of the large devices which are used to meet such demands prevent the drive-train from operating the turbine at a steady state across a full range of speeds. The drive-train is powerful enough to accelerate and decelerate the large turbine through low speeds, but not precise enough to enable steady low-speed turbine operation. This lack of range in turbine performance increases the amount of time required in cranking and cool down operations, and results in an incomplete mapping profile of the turbine.

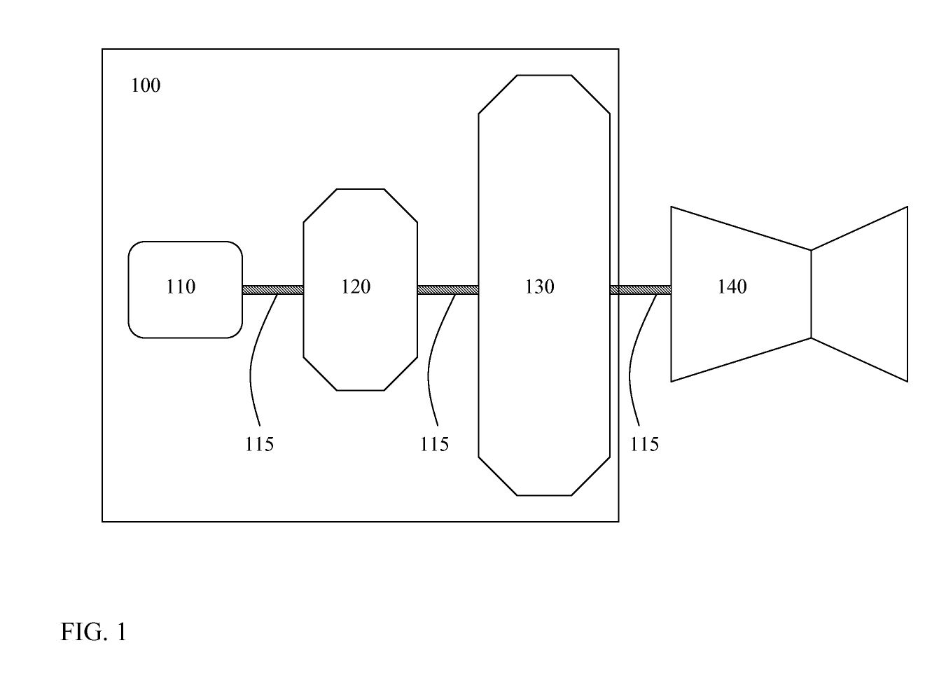

Turning to the FIGURES, embodiments of an apparatus configured to enable steady low-speed turbine operation are shown, where the apparatus may increase mapping capabilities and decrease cool-down and start-up times of the turbine, the rotor and the overall power generation system by powering and managing turbine operation with a motor and multiple torque converters. Each of the components in the FIGURES may be connected via hardwired, wireless, or other conventional means as is indicated in FIGS. 1-6. Specifically, referring to FIG. 1, a schematic top view of an apparatus 100 configured to enable steady low-speed turbine operation is shown in accordance with an aspect of the invention. Apparatus 100 may include a motor 110, at least one shaft 115 connected to motor 110, a first torque converter 120 connected to shaft 115 and a second torque converter 130 connected to shaft 115. Apparatus 100 may enable steady operation of turbine 140 across a range of shaft speeds by generating a power input from motor 110, the power input being relayed via shaft 115 to first torque converter 120 which subsequently relays a torque to second torque converter 130 via shaft 115. Second torque converter 130 may convert the torque into an operational torque which is then supplied to turbine 140 via shaft 115, the operational torque thereby enabling steady low-speed operation of turbine 140. First torque converter 120 and second torque converter 130 may be any conventional torque converter or devices configured to transfer torque and speed from a motor to another device as is known in the art. (i.e. a viscous coupling torque converter, a viscous coupling torque converter having a variable speed transmission, etc.) Motor 110 may be any kind of motor known in the art. (i.e. a synchronous electric motor, a variable speed induction motor, a Load-Commutating Inverter (LCI) etc.).

In an embodiment of the present invention, motor 110 of apparatus 100 may power turbine 140 via at least one shaft 115 coupled to each of turbine 140, torque converter 120 and torque converter 130. In another embodiment of the present invention, motor 110 of apparatus 100 may power turbine 140 via a common shaft 115 coupled to each of turbine 140, torque converter 120 and torque converter 130. In another embodiment of the invention, first torque converter 120 and second torque converter 130 may be connected in series via a common shaft 115.

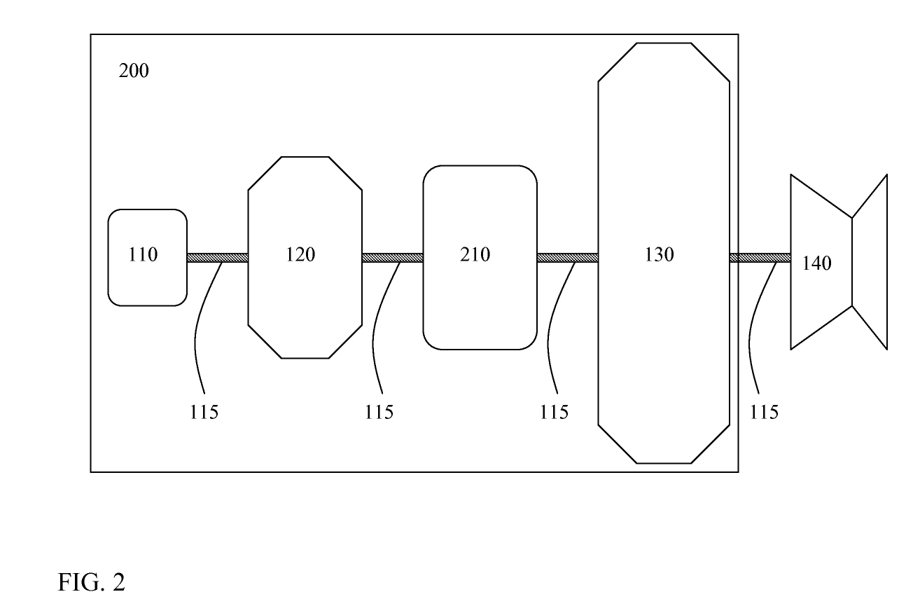

Turning to FIG. 2, a schematic top view of an apparatus 200 is shown according to embodiments of the invention. It is understood that elements similarly numbered between FIG. 1 and FIG. 2 may be substantially similar as described with reference to FIG. 1. Further, in embodiments shown and described with reference to FIGS. 2-6, like numbering may represent like elements. Redundant explanation of these elements has been omitted for clarity. Finally, it is understood that the components of FIGS. 1-6 and their accompanying descriptions may be applied to any embodiment described herein. Returning to FIG. 2, in this embodiment, apparatus 200 may include a second motor 210 which may be interposed between first torque converter 120 and second torque converter 130 on a common shaft 115. In this embodiment, second motor 210 is interposed along a common shaft 115 between torque converter 120 and torque converter 130. In one embodiment, second motor 210 may be in a de-energized state. In another embodiment, second motor 210 may act as a coupling between first torque converter 120 and second torque converter 130.

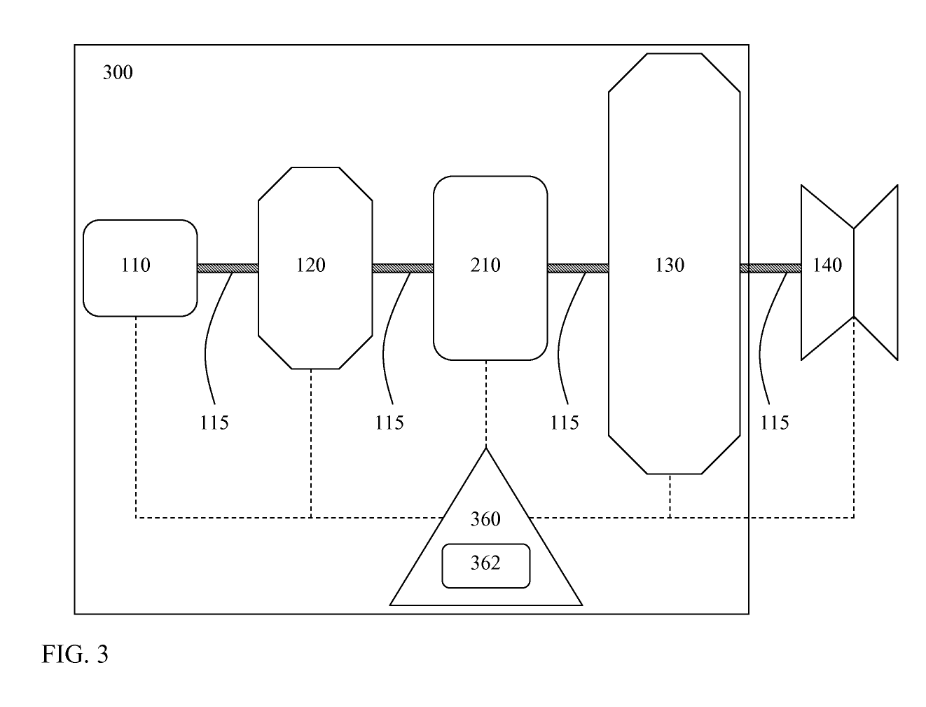

Turning to FIG. 3, a schematic top view of an apparatus 300 is shown including a control system 360 according to embodiments of the invention. In this embodiment, control system 360 may be operably connected to at least one of first motor 110, first torque converter 120, second motor 210, second torque converter 130 and turbine 140. In one embodiment, control system 360 may provide instructions to place second motor 210 in a de-energized state in response to a command such as an operator command. In another embodiment, control system 360 may be configured to manage the speed of turbine 140 by controlling the operations of first torque converter 120 and second torque converter 130. In one embodiment, control system 360 may monitor shaft speed of turbine 140. In another embodiment, control system 360 may maintain a steady operating speed for turbine 140. In another embodiment, control system 360 may adjust the operating speed of turbine 140 across a range of operating speeds. In one embodiment, control system 360 may include a feedback control system 362 which may control a set of guide vanes in either or both of torque converter 120 and torque converter 130. In one embodiment, feedback control system 362 of control system 360 may fix a position of a set of guide vanes in second torque converter 130 and adjust a position of a set of guide vanes in first torque converter 120 to manage the operational torque being supplied to turbine 140, thereby controlling the shaft speed of turbine 140. In another embodiment, control system 360 may adjust a position of a set of guide vanes in at least one of torque converter 120 and torque converter 130 in response to an operator command. In one embodiment, control system 360 may regulate an input of first motor 110 to first torque converter 120.

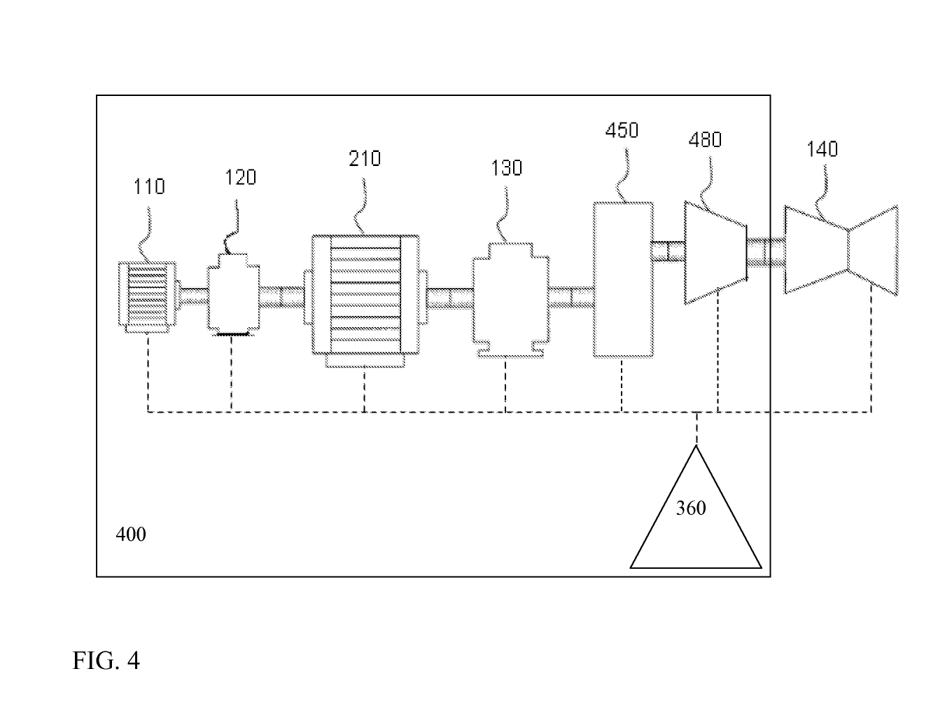

Turning to FIG. 4, a schematic side view of a drive-train apparatus 400 is shown including a drive-train gearbox 450 and a load compressor 480 according to embodiments of the invention. Drive-train gearbox 450 and load compressor 480 may be interposed between turbine 140 and second torque converter 130 along shaft 115 to modify the operational torque being supplied to turbine 140. In one embodiment, drive-train apparatus 400 may be decoupled from gas turbine 140. Motor 110, torque converter 120 and torque converter 130 may power load compressor 480 via drive-train gearbox 450. In another embodiment, drive-train apparatus 400 may be decoupled from gas turbine 140. Motor 110, de-energized motor 210, torque converter 120 and torque converter 130 may power load compressor 480 via drive-train gearbox 450.

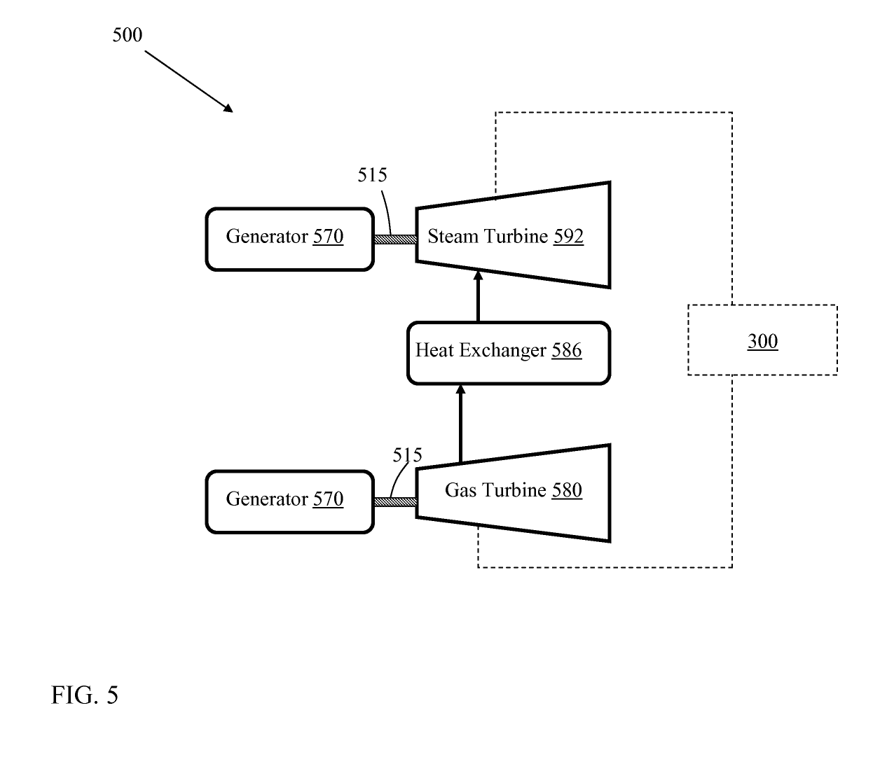

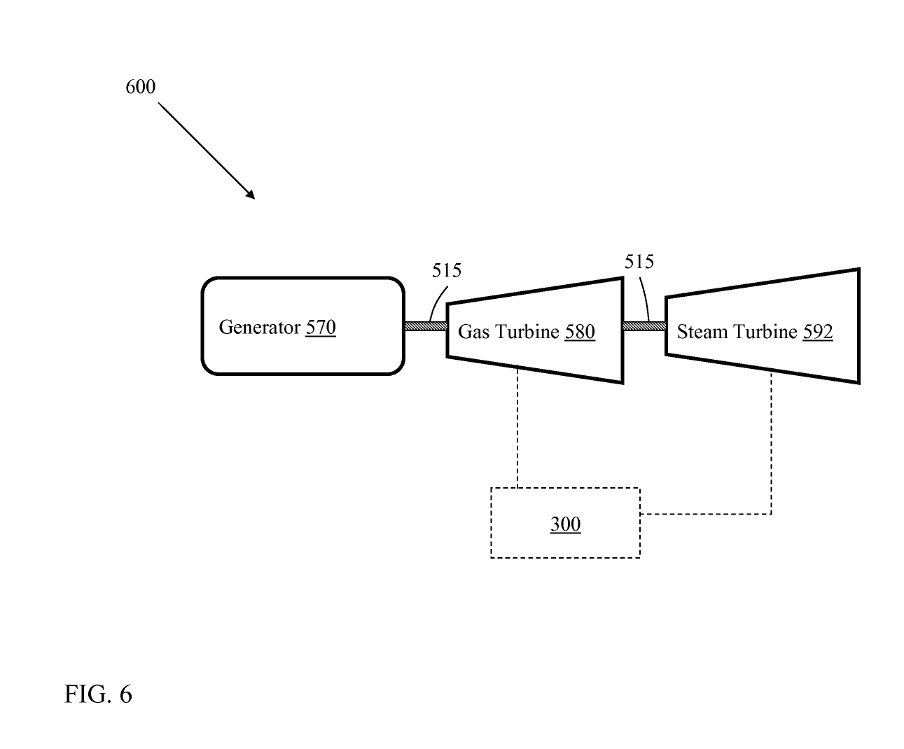

Turning to FIG. 5, a schematic view of portions of a multi-shaft combined-cycle power plant 500 is shown. Combined-cycle power plant 500 may include, for example, a gas turbine 580 operably connected to a generator 570. Generator 570 and gas turbine 580 may be mechanically coupled by a shaft 515, which may transfer energy between a drive shaft (not shown) of gas turbine 580 and generator 570. Gas turbine 580 may be operably connected to apparatus 300 of FIG. 3 or other embodiments described herein. Also shown in FIG. 5 is a heat exchanger 586 operably connected to gas turbine 580 and a steam turbine 592. Heat exchanger 586 may be fluidly connected to both gas turbine 580 and steam turbine 592 via conventional conduits (numbering omitted). Heat exchanger 586 may be a conventional heat recovery steam generator (HRSG), such as those used in conventional combined-cycle power systems. As is known in the art of power generation, HRSG 586 may use hot exhaust from gas turbine 580, combined with a water supply, to create steam which is fed to steam turbine 592. Steam turbine 592 may optionally be coupled to a second generator system 570 (via a second shaft 515). It is understood that generators 570 and shafts 515 may be of any size or type known in the art and may differ depending upon their application or the system to which they are connected. Common numbering of the generators and shafts is for clarity and does not necessarily suggest these generators or shafts are identical. Generator system 570 and second shaft 515 may operate substantially similarly to generator system 570 and shaft 515 described above. Steam turbine 592 may be fluidly connected to apparatus 300 of FIG. 3 or other embodiments described herein. In one embodiment of the present invention (shown in phantom), apparatus 300 may be used to operate either or both of steam turbine 592 and gas turbine 580. In another embodiment, one apparatus 300 may be operably connected to gas turbine 580 and a second apparatus 300 may be operably connected to steam turbine 592. In another embodiment, shown in FIG. 6, a single-shaft combined-cycle power plant 600 may include a single generator 570 coupled to both gas turbine 580 and steam turbine 592 via a single shaft 515. Gas turbine 580 and steam turbine 592 may be fluidly connected to apparatus 300 of FIG. 3 or other embodiments 100, 200, or 400 described herein.

The apparatus and method of the present disclosure is not limited to any one particular drive-train, turbine, generator, power generation system or other system, and may be used with other power generation systems and/or systems (e.g., combined cycle, simple cycle, nuclear reactor, etc.). Additionally, the apparatus of the present invention may be used with other systems not described herein that may benefit from the increased operational range, stability and aerodynamic mapping capabilities of the apparatus described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus comprising:
a turbine coupled to a driveshaft;
a drive-train coupled to the driveshaft;
a first torque convertor coupled to the drive-train, the first torque convertor being configured to deliver an operational torque to the drive-train;
a second torque convertor coupled to the first torque convertor, the second torque convertor being configured to deliver a torque to the first torque convertor;
a first motor coupled to the second torque convertor, the first motor being configured to deliver a power input to the second torque convertor; and
a control system operably connected to at least one of the first torque convertor and the second torque convertor, the control system configured to monitor and adjust a speed of the drive-train by controlling at least one of the operational torque provided by the first torque converter and the torque provided by the second torque converter.

2. The apparatus of claim 1, wherein the first torque convertor, the second torque convertor and the first motor are connected in series by at least one shaft.

3. The apparatus of claim 1, wherein the first motor powers the drive-train.

4. The apparatus of claim 1, further comprising a second motor interposed between the first torque convertor and the second torque convertor along a common shaft.

5. The apparatus of claim 4, wherein the control system provides instructions to put the second motor in a de-energized state in response to an operator command, the de-energized motor for coupling the first torque converter and the second torque converter.

6. The apparatus of claim 5, wherein the control system includes a feedback control system configured to manage a set of guide vanes in at least one of the first torque converter and the second torque converter.

7. The apparatus of claim 5, wherein the control system sets a position of a first set of guide vanes in the first torque convertor and adjusts a position of a second set of guide vanes in the second torque convertor to adjust the speed of the drive-train.

8. A system comprising:
a dynamoelectric machine;
a turbine operably connected to the dynamoelectric machine, the turbine including a driveshaft; and
an apparatus operably connected to the turbine, the apparatus comprising:
a drive-train coupled to the driveshaft of the turbine;
a first torque convertor coupled to the drive-train, the first torque convertor being configured to deliver an operational torque to the drive-train;
a second torque convertor coupled to the first torque convertor, the second torque convertor being configured to deliver a torque to the first torque convertor;
a first motor coupled to the second torque convertor, the first motor being configured to deliver a power input to the second torque convertor; and
a control system operably connected to at least one of the first torque convertor and the second torque convertor, the control system configured to monitor and adjust a speed of the drive-train by controlling at least one of the operational torque provided by the first torque converter and the torque provided by the second torque converter.

9. The system of claim 8, wherein the first torque convertor, the second torque convertor and the first motor are connected in series by at least one shaft.

10. The system of claim 8, wherein the first motor powers the drive-train.

11. The system of claim 8, further comprising a second motor interposed between the first torque convertor and the second torque convertor along a common shaft.

12. The system of claim 11, wherein the control system provides instructions to put the second motor in a de-energized state in response to an operator command, the de-energized motor for coupling the first torque converter and the second torque converter.

13. The system of claim 12, wherein the control system includes a feedback control system to manage a set of guide vanes in at least one of the first torque converter and the second torque converter.

14. The system of claim 13, wherein the control system sets a position of a first set of guide vanes in the first torque convertor and adjusts a position of a second set of guide vanes in the second torque convertor to adjust the speed of the drive-train.

15. An apparatus comprising:
a drive-train;
a first torque convertor coupled to the drive-train, the first torque convertor being configured to deliver an operational torque to the drive-train;
a second torque convertor coupled to the first torque convertor, the second torque convertor being configured to deliver a torque to the first torque convertor;
a first motor coupled to the second torque convertor, the first motor being configured to deliver a power input to the second torque convertor; and
a control system operably connected to at least one of the first torque converter and the second torque converter, the control system adapted to control and adjust a speed of the drive-train by performing actions comprising:
regulating an input of the first motor to the second torque convertor;
monitoring a speed of the drive-train; and
controlling an amount of torque conversion in at least one of the first torque convertor and the second torque convertor.

16. The apparatus of claim 15, further comprising a second motor interposed between the first torque convertor and the second torque convertor along a common shaft.

17. The apparatus of claim 16, wherein the control system provides instructions to put the second motor in a de-energized state in response to an operator command, the de-energized motor for coupling the first torque converter and the second torque converter.

18. The apparatus of claim 15, wherein the control system includes a feedback control system to manage a set of guide vanes in at least one of the first torque converter and the second torque converter.

19. The apparatus of claim 18, wherein the control system is further adapted to adjust low-speed operation in the turbine by performing actions comprising:
setting a position of a set of guide vanes in the first torque convertor; and
adjusting a position of a set of guide vanes in the second torque convertor.

20. The apparatus of claim 15, wherein the first torque convertor, the second torque convertor and the first motor are connected in series by at least one shaft.
